(19) United States
(12) Patent Application Publication
(10) Pub. No.: US 2004/0022898 A1
(43) Pub. Date: Feb. 5, 2004

(54) Method for preparing mineral-containing liquids, especially drinks

(76) Inventor: Werner Zucker, Hamburg (DE)

Correspondence Address: HOWSON AND HOWSON, ONE SPRING HOUSE CORPORATION CENTER, BOX 457, 321 NORRISTOWN ROAD, SPRING HOUSE, PA, 19477, US

(21) Appl. No.: 10/380,122

(22) PCT Filed: Sep. 5, 2001
(86) PCT No.: PCT/EP01/10202

(30) Foreign Application Priority Data
Sep. 26, 2000 (DE) 100-48-002.0

(51) Int. Cl. A23K 1/175

(52) U.S. Cl. 426/74

(57) ABSTRACT

A method for preparing drinks by the exclusive processing of sea water, and to a corresponding drink. No foreign substances need be added to produce the drinks. The contents in sodium, manganese, potassium and calcium are adjusted as required. Certain trace elements that are characteristic of sea water, such as strontium, nitrites, nitrates, phosphates, aluminum, arsenic, cadmium, cesium, lead, mercury and uranium are substantially removed. Positive trace elements such as, for example, zinc, may remain in the liquid in higher concentrations.

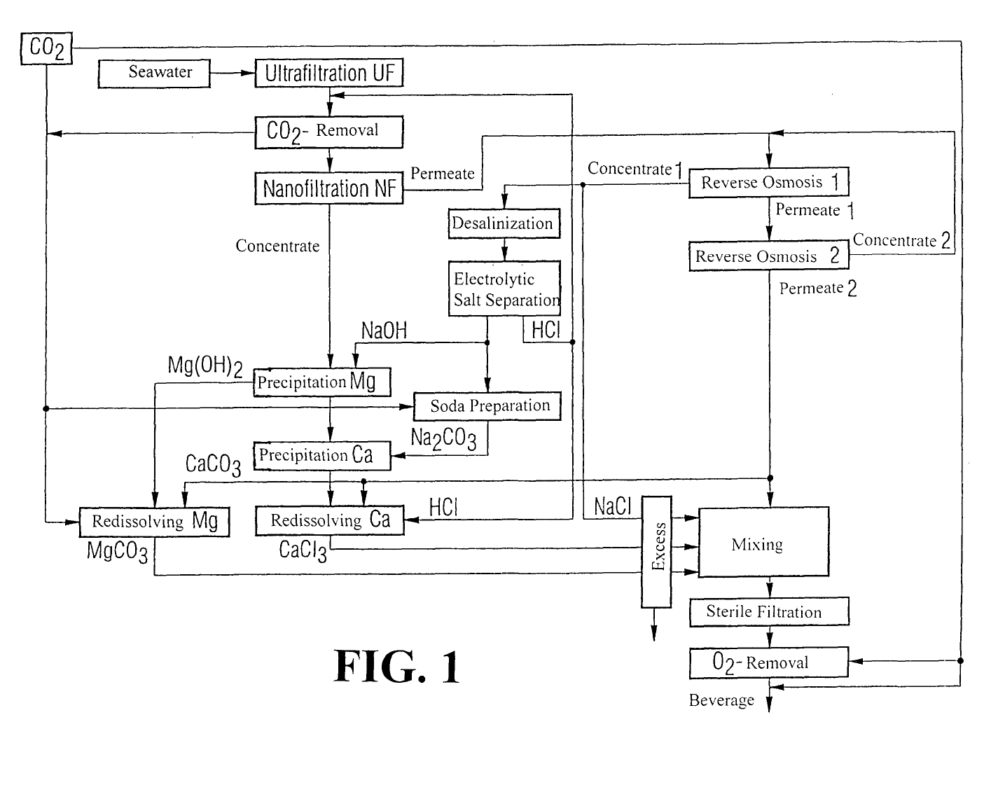

The invention refers to methods for producing mineral-containing liquids for preparation of foods and beverages or infusion solutions by the processing of seawater.

This invention in particular is concerned with beverages that are prepared entirely from seawater in which known processes like fractionation, fortifying, concentration and the like are used. Processes like evaporation, osmosis, biological filtration methods, nanofiltration and the like are also possibilities.

Through this invention only seawater is needed as raw material, and on the other hand foreign additives are neither desired nor necessary in the production.

What is important for this invention on the one hand is that seawater is available in relatively large quantities and on the other hand that it is available worldwide in compositions that do not deviate overly much from each other. The total salt content, which can very relatively strongly dependent on region, is easily reduced in the method in accordance with the invention to the extent required by the end use, thus in the range far under 500 mg/L and for particular purposes even in the range under 20 mg/L.

The preparation essentially takes place in three process steps:

(1) a mechanical preliminary purification of the seawater;

(2) a more or less complete desalinization of the seawater; and

(3) a remineralization of the demineralized seawater.

The desalinization of the seawater can take place in suitable plants, for example membrane plants or evaporation plants. A criterion for the operation of these plants is that the usual foreign substances (for example, antifoaming agents, antideposition agents, flocculants) are not used for processing the seawater.

With these process steps it can be guaranteed that trace elements remain in the seawater in the ratios already present. Moreover, the levels of essential trace elements that are desirable from the standpoint of nutrition (for example, zinc) can be increased in the process steps in some cases.

Through the invention a beverage, a concentrate for a beverage, a food additive, or an intravenously administered infusion solution can be created, namely with the desired composition, without it being a synthetically produced product, since only seawater is used and it is merely optimized in its composition in a targeted fashion.

The proposed dispensing of minerals covers an important part of the recommended daily intake (reference values).

A method in accordance with the invention for preparation of a beverage from seawater is illustrated as an example below by means of the drawing.

The drawing shows a block diagram in which the process steps are given les in the individual blocks.

The starting substance for the beverage goes, as shown in the upper left t of the figure, as seawater into a plant for preparation of a beverage, which in ndicated in the lower right as ready to use beverage in the figure.

The first steps that the seawater goes through in the example are ration, CO₂ removal and nanofiltration. In this way suspended matter and e removed from the seawater, biologically active molecules, microbes and the removed, so that at the end of the nanofiltration step a sterile seawater is , which is then intended to go through further process steps.

In the CO₂ removal step, CO₂ is removed from the seawater and since it eeded in the further course of the preparation of the beverage, can be sent to a recycling loop, which will be discussed in more detail later.

The output of the nanofiltration step is a concentrate or sol, which is sent nesium recovery step (for example precipitation step), and a calcium recovery example precipitation step), and a potassium recovery step. The ation of desirable trace elements can also be increased in the recovery steps. and magnesium are added to the product water (permeate or distillate) in the desalinization plant and redissolved in the mixing step. Hydrochloric CO₂ obtained from the seawater is added to the product water for redissolving. um and sodium are preferably added to the product water as sols.

The other output of the nanofiltration step, thus the permeate, is sent to a reverse osmosis step 1, as can be seen in the right-hand side of the figure. The permeate 1 of reverse osmosis step 1 goes to reverse osmosis step 2, the concentrate of which is sent back to reverse osmosis step 1.

The second output of reverse osmosis step 1, namely the concentrate 1, is divided into two flows, of which one is sent to the mixer to increase the sodium content in the product water and the other is passed through a desalinization and salt separation step. The hydrochloric acid produced in the electrolytic salt separation that is shown as an example is needed at several points in the beverage preparation, as is indicated by the arrows. The sodium hydroxide that forms can be used in the calcium and magnesium recovery steps.

It can be seen from this presentation that the system is essentially closed and besides the feed of seawater and possibly carbonic acid in the case of a highly carbonized beverage (otherwise CO₂ from the plant can be used as described above) no foreign substances are necessary in order to prepare the beverage in accordance with the invention. The individual preparation steps are known in industry, but up to now have not been used in the described form.

The mixing step has one each main inlet and outlet for the incoming desalinated product water and the outgoing beverage, as well as for secondary inlets: for concentrate 1 of reverse osmosis step 1 in order to increase the sodium content, for the sols from the calcium and magnesium recovery steps to increase the contents of calcium and magnesium, and for the concentrate from a potassium recovery step. In the mixing step the “design” of the beverage is formulated and the individual relative concentrations of the components are adjusted in the desired manner and weight.

The output of the mixing step can be sent to a sterilization step in order to remove, for example, biologically active molecules from the beverage, if this is necessary. Finally, oxygen can be removed from the beverage and, according to requirements, carbon dioxide can be added as is also shown schematically by the corresponding line in the drawing.

### EXAMPLE 1

Mineral design for a sports beverage based on seawater:

| | | |
|---|---|---|
| Sodium | 200-400 | mg/L |
| Magnesium | 100 | mg/L |
| Potassium | 150 | mg/L |

The following may be contained as trace elements:

| | | |
|---|---|---|
| Zinc | to 2 | mg/L |
| Iodine | to 50 | μg/L |
| Selenium | to 15 | μg/L |
| Chromium | to 20 | μg/L |
| Copper | to 0.2 | mg/L |

### EXAMPLE 2

Mineral designed for brain/business beverage based on seawater:

| Magnesium | 75 | mg/L |
|---|---|---|
| | Ratio 1:1 | |
| Calcium | 75 | mg/L |
| Potassium | 100 | mg/L |
| Sodium | <20 | mg/L |
| Zinc | . . . 2.5 | mg/L |
| Iron | . . . 2 | mg/L |
| Copper | 0.25 | mg/L |
| Iron | 40 | μg/L |
| Chromium | 15 | μg/L |

### EXAMPLE 3

Basic mineral beverage made from seawater:

| | | |
|---|---|---|
| Calcium | 100 | mg/L |
| Magnesium | 100-150 | mg/L |
| Sodium | 100 | mg/L |
| Chloride | 150 | mg/L |
| Potassium | 100 | mg/L |
| Hydrogen carbonate | 500 | mg/L |
| and Zinc and Iron. | | |

### EXAMPLE 4

Beauty beverage based on seawater:

| | | |
|---|---|---|
| Calcium | 250 | mg/L |
| Potassium | 100 | mg/L |
| Magnesium | 50 | mg/L |
| Zinc | to 2 | mg/L |
| Fluoride | to 1 | mg/L |
| Iodine | to 50 | μg/L |
| Copper | to 0.2 | mg/L |
| Iron | to 2 | mg/L |
| and possibly: | | |
| Manganese | to 0.5 | mg/L |
| Molybdenum | to 20 | μg/L |

### EXAMPLE 5

Health beverage based on seawater for
prevention of cardiovascular diseases:

| | | |
|---|---|---|
| Magnesium | 200 | mg/L |
| Potassium | 150 | mg/L |
| Calcium | 50 | mg/L |
| Sodium | <20 | mg/L |
| Chloride | 100 | mg/L |
| Selenium | to 20 | μg/L |
| Iodine | to 25 | μg/L |

Small amount of carbon dioxide according to requirement,

1. A method for producing liquids for the preparation of foods or beverages or of infusion solutions by processing seawater, which is characterized by the fact that exclusively seawater without other additives is used for the beverage.

2. A method according to claim 1, which is characterized by the fact that certain “negative” trace elements that are typical of seawater such as strontium, nitrites, nitrates, phosphates, aluminum, arsenic, cadmium, cesium, lead, mercury and uranium are more or less removed from the seawater, and “positive” trace elements that are typical of seawater are increased in concentration or are left to a large extent or are removed.

3. A method according to one of claims 1 or 2, which is characterized by the fact that the content of sodium is adjusted up to about 400 mg/L, the concentration of magnesium is adjusted up to about 200 mg/L, the concentration of potassium is adjusted up to about 150 mg/L and the concentration of calcium is adjusted up to about 250 mg/L, as desired.

4. A method for preparation of a mineral design for a sports beverage based on seawater with a content of sodium of about 200-400 mg/L, magnesium of about 100 mg/L and potassium of about 150 mg/L.

5. A method according to claim 4, where sodium hydrogen carbonate is used instead of the chloride compound for purposes of regulating the base balance, where the following trace elements can be contained: zinc about 2 mg/L, iodine about 50 μg/L, selenium up to about 15 μg/L, chromium up to about 20 μg/L, copper up to about 0.2 mg/L; where strontium, nitrites, nitrates, phosphates, aluminum, arsenic, cadmium, cesium, lead, mercury and uranium are essentially removed and where “seawater-appropriate” amounts of boron and vanadium are left or are removed.

6. A method for producing a mineral design for a brain/business beverage based on seawater with a content of about 75 mg/L magnesium, about 75 mg/L calcium, about 100 mg/L potassium and >20 mg/L sodium.

7. A method according to claim 6, where the following contents are established: zinc up to about 0.2 mg/L, iron up to about 2 mg/L, copper up to about 0.25 mg/L, iodine up to about 40 μg/L, and chromium up to about 15 μg/L; where strontium, nitrites, nitrates, phosphates, aluminum, arsenic, cadmium, cesium, lead, mercury and uranium are essentially removed and “seawater-appropriate” amounts of boron and vanadium are left or are removed.

8. A method for producing a mineral design for a base mineral beverage based on seawater with a content of about 100 mg/L calcium, about 100 mg/L magnesium, about 100 mg/L sodium, about 150 mg/L chloride, about 100 mg/L potassium, about 600 mg/L hydrogen carbonate, and zinc and iron.

9. A method according to claim 8, in which arsenic, cadmium, strontium, nitrites, nitrates, phosphates, aluminum, cesium, lead, mercury and uranium are essentially removed and “seawater-appropriate” amounts of boron and vanadium are left or are removed.

10. A method for producing a mineral design for a beauty beverage based on seawater with a content of about 250 mg/L calcium, about 100 mg/L potassium, about 50 mg/L magnesium, up to about 2 mg/L zinc, up to about 1 mg/L fluoride, up to about 50 μg/L iodine and up to about 0.2 mg/L copper and up to about 2 mg/L iron and alternatively up to about 0.5 mg/L manganese and up to about 20 μg/L molybdenum.

11. A method according to claim 10, in which strontium, nitrites, nitrates, phosphates, aluminum, arsenic, cadmium, cesium, lead, mercury and uranium are essentially removed and “seawater-appropriate” amounts of boron and vanadium are left or are removed.

12. A method for producing a mineral design for a health beverage based on seawater with a content of about 200 mg/L magnesium, about 150 mg/L potassium, about 50 mg/L calcium, up to about 20 mg/L sodium, about 100 mg/L chloride, up to about 20 μg/L selenium and up to about 25 μg/L iodine.

13. A method according to claim 12, where the trace elements that are typical of seawater are left, strontium, nitrites, nitrates, phosphates, aluminum, arsenic, cadmium, cesium, lead, mercury and uranium are removed, and where “seawater-adequate” amount of boron and vanadium are left or are removed.

14. A method according to at least one of claims 1 to 13, which is characterized by the fact that carbon dioxide is added in the production or bottling of a beverage.

15. A beverage, which is characterized by the fact that a liquid or solid compressed concentrate according to one of claims 1 to 13 is prepared with the aid of distilled water, tap water or another liquid.
